(19) United States
(12) Patent Application Publication
(10) Pub. No.: US 2005/0193340 A1
(43) Pub. Date: Sep. 1, 2005

(54) Apparatus and method regarding dynamic icons on a graphical user interface

(76) Inventors: James T. Amburgey, Mt. Sterling, KY (US); Andrew C. Donovan, Lexington, KY (US); Lyle B. McMillan, Georgetown, KY (US); David A. Pulley, Midway, KY (US); Kenneth R. Woodruff, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/790,328

(22) Filed: Mar. 1, 2004

(51) Int. Cl. G06F 3/00

(52) U.S. Cl. 715/709; 715/708; 715/705; 715/859; 715/850; 715/851; 715/825; 715/861; 715/817; 715/821; 715/822; 715/823; 715/810; 715/846; 715/841

(57) ABSTRACT

A multifunctional device, such as a multifunction printer, enabling dynamic configurations of the icons on a graphical user interface. In some embodiments, the dynamic configurations create context specific icon layouts. Additionally, in some embodiments, a single icon button can be dynamically configured to represent a particular workflow operation conventionally requiring several inputs by a user at the graphical user interface. Specifically, the display of some embodiments can dynamically change to reflect the “next step” context within a workflow operation. Also, the display of some embodiments can dynamically change to reflect a unique user-context on the graphical user interface.

### BACKGROUND OF THE INVENTION

Some multifunctional imaging devices or printers have a graphical user interface or touch screen to show the status of the device, allow user interaction, prompt user actions, or the like. In an office setting, most multifunctional imaging devices can perform many operations, which can require several icons to be displayed on the screen at one time. As such, substantial time may be consumed to show the end user how to use each function indicated on the touch screen or to navigate through unnecessary (i.e., unnecessary to a particular user) icons.

### SUMMARY OF THE INVENTION

The multifunctional device of the present invention enables dynamic configurations of the icons or icon buttons to create context specific icon layouts, which may enhance usability and/or minimize end user training requirements.

Certain icons can be configured to perform a workflow operation or navigate a user through the workflow operation through selection of a single icon (the initial icon button) on the home screen of the graphical user interface. For example, the display of some embodiments can dynamically change to reflect the “next step” context (next step screens). In other words, one or more icon buttons can be displayed to guide the user to execute the correct next step in the particular workflow operation triggered by the initial icon button selected. For example, in some embodiments, the device can be programmed to provide multiple scans and multiple scan profiles within one business process operation initiated at the multifunctional printer.

The display can also dynamically change to reflect a unique user-context (context screens) on the graphical user interface with icon buttons for the particular context. For example, the particular user context can be preprogrammed for the user and selected via user login/authentication or by selecting a particular context from an initial icon button on the home screen.

Some embodiments can be programmed to restore the display to a default home screen after the completion of a workflow operation either through a cancel icon-button, a timeout, based on certain error conditions, or the like.

In some embodiments, the welcome or home screen, next step screens, and context screens can be maintained and managed on a central server.

Some embodiments are directed toward a network comprising a central computer having a memory module for storing a plurality of customized icon configuration files corresponding to a plurality of network users' personal preferences. Each of the plurality of customized icon configuration files has specific icons arranged in a specific order based upon the personal preferences of a respective network user. A plurality of imaging devices are coupled to the network. Each imaging device has a graphical user interface adapted to display at least one of the plurality of customized icon configurations associated with a current user of the imaging device.

Some embodiments are also directed to a method of using an imaging device. The method includes activating a user authentication script at the imaging device and authenticating a first user. Then, a first one of a plurality of icon configuration files preprogrammed for the first user is retrieved and a first configuration of icons are displayed on a graphical user interface corresponding to the first one of the plurality of icon configuration files. A user authentication script can be activated at the imaging device subsequent to displaying the first configuration of icons to authenticate a second user. Upon authentication, a second one of the plurality of icon configuration files preprogrammed for the second user is retrieved and a second configuration of icons is displayed on the graphical user interface. The second configuration of icons correspond to the second one of the plurality of icon configuration files.

Some embodiments are directed toward a method of displaying icons on a graphical user interface of an imaging device. The method includes displaying a home screen having a plurality of icons representing a plurality of operations. At least one of the plurality of icons is related to a specific business operation typically requiring multiple operations to be performed sequentially from the home screen. At least one of the plurality of icons relating to a multi-operation business operation is selected. A first step screen having a first prompt to perform a first of the multiple operations is displayed. A second step screen is displayed after the first step screen. The second step screen has a second prompt to perform a second of the multiple operations subsequent to the first prompt. The second prompt is automatically initiated upon the first step of the multiple step operation being performed and without returning to the home screen.

Some embodiments are directed toward a method of verifying status information on a graphical user interface of an imaging device. The method includes displaying a home screen having a plurality of icons representing a plurality of operations and selecting one of the plurality of icons. A specific operation is then initiated corresponding to the icon selected. Status information indicating whether the operation was completed successfully is displayed on the graphical user interface. A first indication appears if the operation was successful and a second indication appears if the operation was unsuccessful. A first screen having a first icon is selectively displayed corresponding to the first indication and a second screen having the first icon and a second icon is selectively displayed corresponding to the second indication. The second icon allows a user to view further details regarding the unsuccessful operation.

Some embodiments are directed toward a method of verifying information on a graphical user interface of an imaging device. The method includes displaying a home screen having a plurality of icons representing a plurality of operations and selecting the one of the plurality of icons. A specific operation is initiated corresponding to the icon selected and information is extracted from a document placed on the imaging device. At least a portion of the extracted information is displayed on the graphical user interface. The accuracy of the extracted information can be verified on the display.

Further aspects of the present invention, together with the organization and operation thereof, will become apparent from the following detailed description of the invention when taken in conjunction with the accompanying drawings.

### BRIEF DESCRIPTION OF THE DRAWINGS

FIG. 1 is an illustration of one embodiment of a network hosting one or more multifunctional imaging devices of the present invention.

FIG. 2 is an exemplary illustration showing a sequence of icons and information displayed on a graphical user interface during an exemplary log-on sequence.

FIG. 3 is an exemplary illustration showing a sequence of icons and information displayed on a graphical user interface to implement multiple scans within one business process operation.

FIG. 4 is an exemplary illustration showing a sequence of icons and information displayed on a graphical user interface for a scan verification process.

FIG. 5 is an exemplary illustration showing a sequence of icons and information displayed on a graphical user interface to provide on screen status verification.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

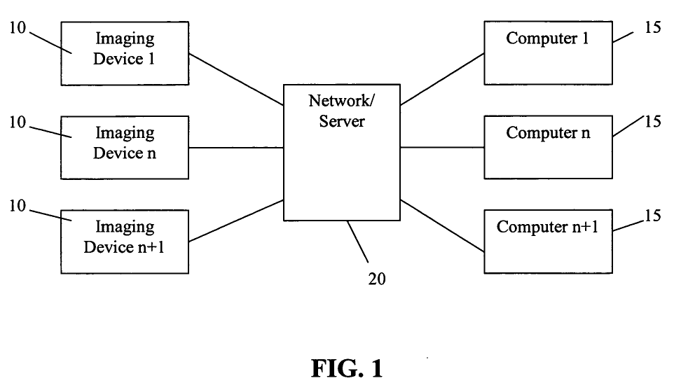

Multifunctional imaging devices 10, such as multifunctional printers having the capability of performing one or more operations, like printing, scanning, copying, faxing, and emailing, can be found in many business environments. Some businesses have several multifunctional imaging devices 10 dispersed throughout one or more buildings. Some or all of these multifunctional imaging devices 10 can be networked together as shown in FIG. 1. Furthermore, as illustrated in FIG. 1, the multifunctional devices can be networked to one or more computers 15. The computers 15 can send data to any one of the networked multifunctional devices illustrated in FIG. 1 via the network. Additionally, any one of the networked multifunctional devices 10 illustrated in FIG. 1 can also communicate with and/or send information to any one of the computers 15 illustrated in FIG. 1. Although portions of this detailed description are described with respect to the network 20 illustrated in FIG. 1, it is understood that other configurations of a network are possible. Furthermore, it is also understood that a network is not necessarily required to practice some aspects of the present invention.

Since these multifunctional devices 10 can perform many operations, several icons 25 may be displayed on graphical user interface 30, such as a touch screen, at one time. However, some of the icons (and related functions) are not used by all users of the multifunctional device. In most conventional devices, each user will be faced with the same display. As such, substantial time may be consumed training each user to use each function indicated on the touch screen or to navigate through unnecessary (i.e., unnecessary to a particular user) icons.

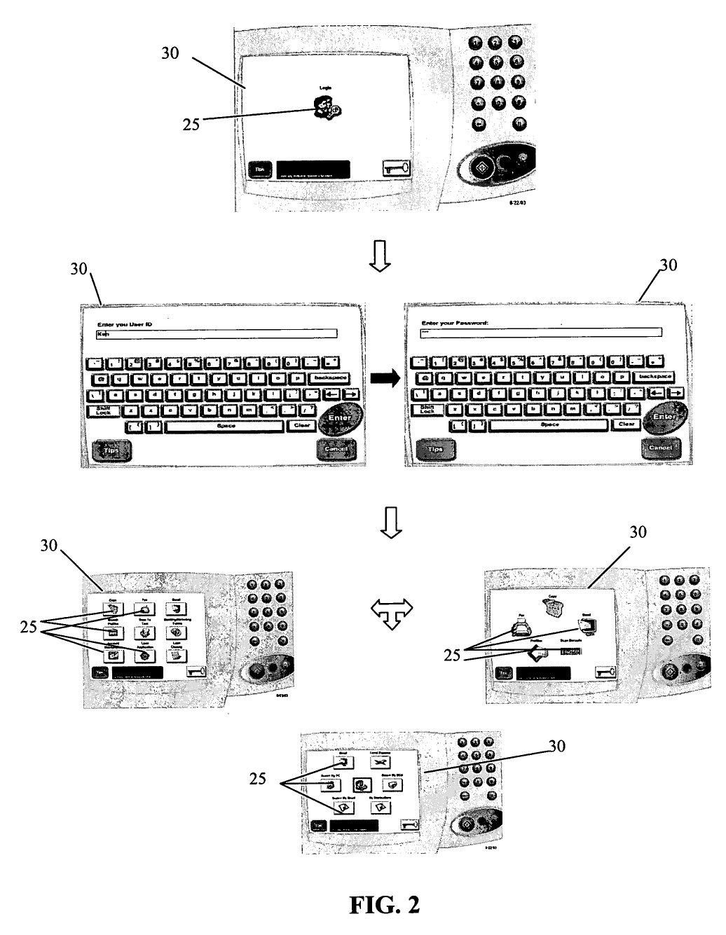

Some embodiments of the present invention include the capability of dynamically changing icons 25 to reflect a set of individual user preferences. Specifically, a customized icon configuration file can be created for each user and saved to the network or a central computer. The specific icons on a user's personalized icon screen can vary based on the individual's preferences or business role. Since each employee within a business may perform specific daily tasks that other employees don't, the icons 25 on the graphical user interface 30 can be individualized for each employee. For example, as illustrated in the bottom of FIG. 2, some employees may routinely use nine or more icons while other employees may only use only a few icons. Thus, the specific functions used by an employee can be represented by icons 25 appearing on the display when logged in. The functions that are not be used by a particular user do not have to be displayed on that user's home screen or welcome screen. Each user or an administrator can create and define the dynamic icon configuration for each user.

Existing Lexmark Document Distributor (LDD) software, sold by Lexmark International, Inc. of Lexington, Ky. can enable the customized layout. Each customized icon configuration file can be saved to a central server and associated with a login ID. Since the icon configuration files are stored on the LDD server, a user can access his personalized icon layout from any device 10 that has the login script loaded and is connected to the server. Thus, if a user were to login at a specific multifunctional imaging device 10 within the network, the displayed icons and their associated arrangement would reflect that user's individual preferences.

In some embodiments, a “Login” icon 25 can be displayed along with the standard icon buttons 25 on a default home screen. Thus, a user that is comfortable with the standard arrangement of icons on the home screen does not have to log in. Additionally, not all users will necessarily be given personalized icon configurations. Thus, some users may have no option other than to use the default home screen. However, in some embodiments, every user must log on to the device in order to use it. As such, the initial welcome screen may be configured with a single “Login” icon button 25 as illustrated in FIG. 2.

Regardless of the configuration of the welcome screen, the “Login” icon button 25 can be associated with a script that authenticates the user and handles the dynamic icon changes. For example, the script can use existing LDD functionality to prompt the user for required inputs such as user ID and password. As illustrated in FIG. 2, pressing the “Login” button initiates the script that authenticates the user by prompting the user for a user ID and password. After successfully authenticating the user, the script sends that user's icon configuration file to the device to present a personalized home screen or welcome screen. Since the icon configuration files are stored on the LDD server, an end-user can access his personalized icon layout from any device that has the login script loaded and is connected to the server.

To return to the main login or welcome screen, any of the personalized icon screens can include a “Logout” icon button which would be associated with a script that restores the display back to it's default welcome screen. Some embodiments can also include features that automatically log a user off of the device after a specified period of inaction.

Referring now to FIG. 2, an exemplary illustration of a graphical touch screen user interface 30 is illustrated as part of a “Login” operation. Specifically this figure shows a workflow operation for an individual to log on to a multifunctional printer. As illustrated in the sequence of operations, an operator would first indicate an intention to log on. In the illustrated embodiment, the user would touch the icon 25 on the touch screen. Then, the user is prompted for a user ID followed by a password. Assuming the user ID and password are entered correctly and recognized by the server, the icon configuration file for that user will be received by the device to arrange a set of icons 25 on the screen according to the user's preferences. Several exemplary arrangements of icons are illustrated at the bottom of FIG. 2.

In another aspect of the invention, specific workflow operations can be initiated by selecting a single icon button 25. For example, some business transactions typically require several operations (i.e., workflow operations) to occur at the multifunctional imaging device. In some situations, operations have to occur in a specific order, while in other situations, the operations can occur in many different orders. Conventionally, each of these operations would be done individually at the multifunctional imaging device to complete the specific business transaction. Specifically, the user would typically perform a first operation by initiating an action at the home screen of the graphical user interface 30. Then, each subsequent operation would also be initiated at the home screen. In other words, none of the operations would be automatically prompted on the graphical user interface 30 even though the operations tend to be performed together as part of a single workflow operation.

In some industries, several items need to scanned within a single business transaction. Conventionally, a scan of a first item is initiated at the home screen. Upon completion of the scan, a scan of a second item is also initiated at the home screen. In other words, the device never prompts the user to scan the second item even though the second item also tends to be scanned when the first item is scanned in this business or industry.

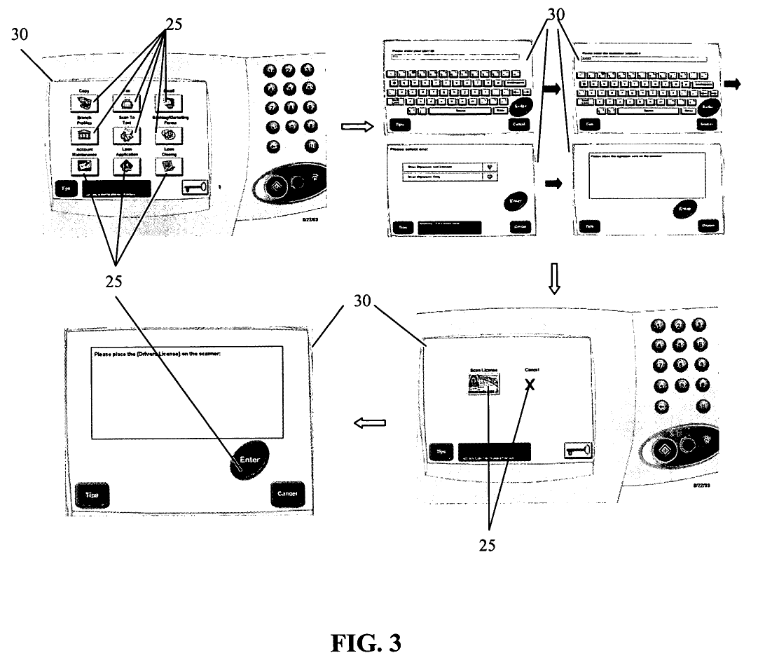

For example, as illustrated in FIG. 3, an employee at a financial institution may have a need to scan both a signature card and a driver's license to open a checking account. This example shows how the display 30 with an exemplary icon configuration to prompt the user to initiate a next step within this workflow operation (i.e., to scan both a signature card and a license to open a checking account through the activation of a single icon on the home screen). This application requires two different scan profiles. One scan profile creates a 300 dpi bi-level Tiff image file of the signature card, and the other profile creates a high-resolution color scan of the driver's license. Instead of implementing two separate scan profiles requiring the end-user to select each profile separately, the touch screen icons 25 are changed on the fly to prompt the user to accomplish the required scans. The icon screen changes are presented within one seamless set of user-interface prompts that guide the user through the scanning process. Such a task can be built into an icon button of a graphical user interface 30 as illustrated in FIG. 3.

FIG. 3 illustrates a sequence of exemplary icons 25 and information displayed on the graphical user interface 30 to implement the two scans discussed above within one workflow operation. As illustrated, the user would activate the account maintenance button illustrated on the home screen to begin the application. Upon selecting the account maintenance icon button, a signature card scanning script is invoked to scan the signature card. This script can also use existing LDD functionality to prompt the user for required inputs. For example, the script may prompt the user to supply a User ID and Account Number. FIG. 3 illustrates an exemplary prompt for a user ID and account numbers within the application.

The script can also prompt the user to indicate whether they want to scan both the signature card and the license or whether they want to only scan the signature card. Assuming both the signature card and license are to be scanned, the graphical user interface 30 will then display a prompt for the user to scan one of those items. Specifically, it can initiate the scan of the signature card first, as illustrated in FIG. 3. After that item is scanned, the script copies an icon configuration file to the device to dynamically change the icons 25 and prompt the user to scan the driver's license. As illustrated, the user can be provided with two options at this point since the next screen contains a “Scan License” icon button and a “Cancel” icon button. Each buttons is associated with a script. The “Cancel” icon button references a script that simply sends the original welcome screen or home screen icon layout to the device to restore the welcome screen. The “Scan License” icon button initiates a script that prompts and executes the driver's license scanning process.

Although the ability to perform multiple scan profiles within one business process operation was illustrated in FIG. 3 with respect to scans of signature cards and driver's licenses, it is understood that the present invention has other applications. Specifically, several industries have business operations that require multiple scans to be performed within one business or workflow operation. However, as disclosed above, each of the scans within a multiscan is typically initiated at the home or welcome icon arrangement. In other words, when one scan is complete, the graphical user interface 30 does not prompt a second scan. Rather, each scan has to be performed individually starting at the home or welcome icon display screen.

The multiple scan profile discussed above can be provided as a “customized” icon 25 for specific users when logged onto the device or it can be provided as a standard icon 25 on a non-customized or default home page.

In another aspect of the invention, the device can provide prompting based upon the status of an operation at the device. Conventionally, feedback regarding the status of a scan operation is provided to the user by printing a confirmation page. While waiting for the confirmation page, the user may log-out, may be automatically logged-out, or may initiate another operation at the device. If the operation being confirmed failed, the user will conventionally have to initiate the operation from the beginning due to subsequent actions. In other words, the user is not automatically prompted on the graphical user interface 30 to execute additional business process steps in the event of a failure.

By using the dynamic icon configuration capability, a status screen can be constructed by creating icon configuration files on the fly and conditionally presenting feedback as appropriate after performing verification within the LDD script. For example, after an item is scanned, the script can verify the status of the scan by checking certain parameters and cause an appropriate icon configuration to be displayed regarding the status of the task. In some situations, the script can also prompt the user to take one or more additional steps depending upon the status of the task. The feedback screen could provide simple confirmation information such as a “Success” or “Failure” indication. In some embodiments, appropriate “next step” icon buttons with associated LDD scripts could be conditionally presented based upon the status of the previous operation or based upon data extracted from a previously scanned document.

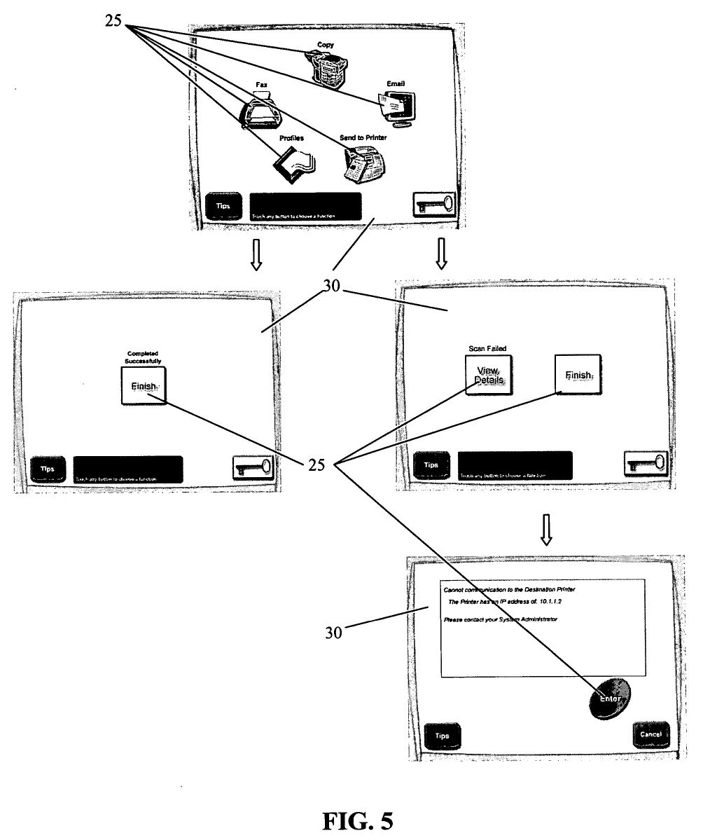

As discussed above, some embodiments can also verify the status of an operation performed at the device 10 on the graphical user interface 30. For example, FIG. 5 illustrates a sequence of exemplary icons 25 and information displayed on the graphical user interface 30 to provide on screen status verification. Although this particular example is discussed with respect to scanning, it is understood that is applicable to other operations. After a scan is invoked, the graphical user interface 30 can display the status of the operation. Specifically, it can indicate that the operation was completed successfully if no errors occurred. However, if an error did occur, the graphical user interface 30 can display dynamic icons on the fly to prompt the user of the error and in some instances to take corrective action. For example, the graphical user interface 30 can present a user with the choice of viewing the details of the error, which shows a detailed reason why the scan failed, or it can prompt the user to finish, which can return the user back to the main screen.

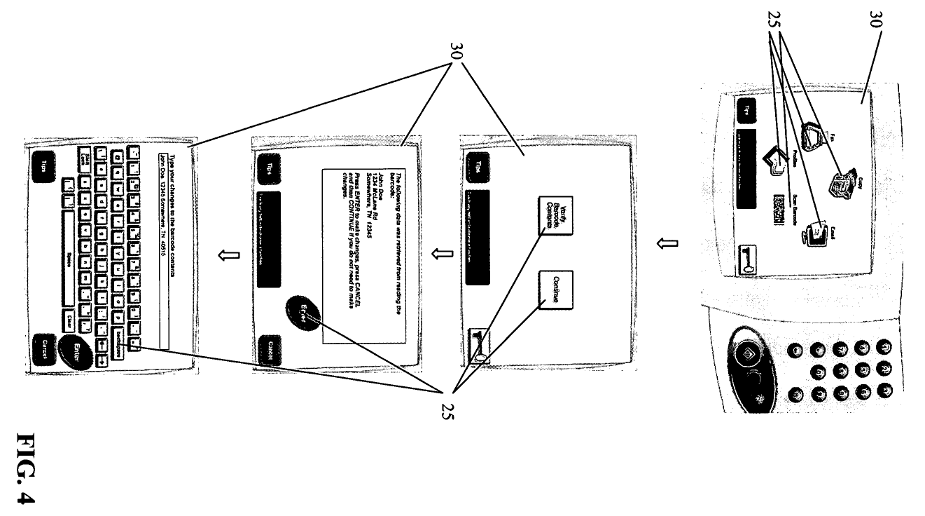

In another aspect of the invention, the device 10 can provide interactive validation or prompting based upon data extracted from scanned documents. Some LDD scripts can extract data from scanned documents by using optical character recognition (OCR) or barcodes. FIG. 4 illustrates a sequence of exemplary icons and information displayed on a graphical user interface 30 for one type of scan verification process. As illustrated, this verification process extracts data from a scanned barcode. The process is initiated by pressing the illustrated “Scan Barcode” button. This causes the document to be scanned and changes the icons on the graphical user interface 30 as illustrated. Once the document has been scanned, the graphical user interface 30 can prompt the user to verify the contents of the barcode or to continue without verification. If the user chooses to verify the barcode contents, the contents of the barcode can be displayed. Furthermore, in some embodiments, the user can be prompted to make changes to the contents of the barcode or continue without changing any information. The changes (if any) can be made at the device without the need to make the changes elsewhere and scan the document again.

In an exemplary operation, a user can access his personal icon configuration file by verifying his identity at the imaging device 10. Although this can be done many different ways, in some embodiments, the user will enter a user ID and password at a graphical user interface 30 of the imaging device. The imaging device 10 will then verify this information with a stored password for the user ID. Upon verification, the user's personal preferences for both the type and arrangement of icons 25 will be retrieved and displayed on the graphical user interface 30. One or more tasks can then be performed from this personalized home screen. Some of the icons 25 can be associated with tasks requiring more than one step/operation to be performed. One or more of the icons can be configured to dynamically change to guide the user through the specific workflow operation. The user can log-out to eliminate his personal icon configuration from the graphical user interface 30, or he can be automatically logged-off after a certain period of inaction.

Some aspects of the present invention have particular utility in reducing training requirements for people that utilize imaging devices. Some aspects also reduce the amount of time spent at the imaging device to complete one or more tasks and/or the number of commands, key strokes, and the like to complete one or more tasks. Some aspects of the invention reduce the amount of time needed to obtain feedback regarding a performed task, and additionally, some aspects can reduce the number of steps required to correct an unsuccessful task. These and other uses of the present invention are apparent from the above description.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

Various features of the invention are set forth in the following claims.

1. A network comprising:
a central computer having a memory module for storing a plurality of customized icon configuration files corresponding to a plurality of network users' personal preferences, each of the plurality of customized icon configuration files having specific icons arranged in a specific order based upon the personal preferences of a respective network user; and
a plurality of imaging devices coupled to the network, each imaging device having a graphical user interface adapted to display at least one of the plurality of customized icon configurations associated with a current user of the imaging device.

2. The network of claim 1, wherein the graphical user interface on at least some of the plurality of imaging devices includes a home screen that includes an authentication icon to authenticate the current user.

3. The network of claim 2, wherein activation of the authentication initiates a log-in script to authenticate the current user.

4. The network of claim 2, wherein the customized configuration file associated with the current user is received by the imaging device upon authentication of the user.

5. The network of claim 2, further comprising at least one additional customized icon configuration file having a default icon arrangement not associated with one particular user.

6. The network of claim 5, wherein the default icon arrangement includes the authentication icon.

7. The network of claim 1, wherein each network user's personal preferences regarding the arrangement and type of icons to be displayed on a graphical user interface.

8. A method of using an imaging device, the method comprising:
activating a user authentication script at the imaging device;
authenticating a first user;
retrieving a first one of a plurality of icon configuration files, the first one of the plurality of icon configuration files being preprogrammed for the first user;
displaying a first configuration of icons on a graphical user interface corresponding to the first one of the plurality of icon configuration files;
activating a user authentication script at the imaging device subsequent to displaying the first configuration of icons;
authenticating a second user;
retrieving a second one of the plurality of icon configuration files, the second one of the plurality of icon configuration files being preprogrammed for the second user;
displaying a second configuration of icons on the graphical user interface corresponding to the second one of the plurality of icon configuration files.

9. The method of claim 8, wherein the first one of the plurality of icon configuration files represents the personal preferences of the first user regarding the type and arrangement of icons displayed on the graphical user interface.

10. The method of claim 9, wherein the second one of the plurality of icon configuration files represents the personal preferences of the second user regarding the type and arrangement of icons displayed on the graphical user interface.

11. The method of claim 8, further comprising displaying an icon on the graphical user interface adapted to activate the user authentication script.

12. The method of claim 8, wherein the steps of retrieving a first one of a plurality of icon configuration files and retrieving a second one of the plurality of icon configuration files comprises sending the respective icon configuration file to the device from a central computer.

13. The method of claim 12, wherein the step of sending the respective icon configuration file is initiated by the script.

14. A method of displaying icons on a graphical user interface of an imaging device, the method comprising:
displaying a home screen having a plurality of icons representing a plurality of operations, at least one of the plurality of icons being related to a specific business operation typically requiring multiple operations to be performed sequentially from the home screen;
selecting the at least one of the plurality of icons related to a specific business operation typically requiring multiple operations to be performed sequentially from the home screen;
displaying a first step screen having a first prompt to perform a first of the multiple operations;
displaying a second step screen after the first step screen, the second step screen having a second prompt to perform a second of the multiple operations subsequent to the first prompt, the second prompt being automatically initiated upon the first of the multiple operation being performed and without returning to the home screen.

15. The method of claim 14, wherein the business operation typically requires a first document to be scanned according to a first configuration of a scanner and a second document to be scanned according to a second configuration of the scanner.

16. A method of verifying status information on a graphical user interface of an imaging device, the method comprising:
displaying a home screen having a plurality of icons representing a plurality of operations;
selecting the one of the plurality of icons;
initiating a specific operation corresponding to the icon selected;
displaying a status information on the graphical user interface, the status information indicating whether the operation was completed successfully, a first indication appears if the operation was successful and a second indication appears if the operation was unsuccessful;
selectively displaying a first screen having a first icon corresponding to the first indication; and selectively displaying a second screen having the first icon and a second icon corresponding to the second indication, the second icon allowing a user to view further details regarding the unsuccessful operation.

17. A method of verifying information on a graphical user interface of an imaging device, the method comprising:
displaying a home screen having a plurality of icons representing a plurality of operations;
selecting one of the plurality of icons;
initiating a specific operation corresponding to the icon selected;
extracting information from a document placed on the imaging device;
displaying at least a portion of the extracted information on the graphical user interface; and
verifying the accuracy of the extracted information displayed.
